(19) United States
(12) Patent Application Publication
(10) Pub. No.: US 2002/0087227 A1
(43) Pub. Date: Jul. 4, 2002

(54) System and method for production management

(75) Inventors: Yoshio Tozawa, Tokyo-to (JP); Yoichiro Sumito, Funabashi-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 09/998,285

(22) Filed: Oct. 31, 2001

(30) Foreign Application Priority Data
Nov. 2, 2000 (JP) 2000-336635

(51) Int. Cl. G06F 17/60; G06F 19/00

(52) U.S. Cl. 700/95; 705/28; 700/99; 700/100; 700/106

(57) ABSTRACT

To reduce lead time from order to delivery of a product made of a plurality of parts, and manage the order of parts without waste, a first identifier (tie ID or linkage ID) based on the planned production date of the product, and a second identifier representing the length of time from the order time of each part to the planned production date of the product are defined. Forecast information, which indicates the planned production quantity of the product, is associated with the identifiers. The ordered quantity of a part is associated with the identifiers. The current order information is calculated based on the forecast information and past order information based on the identifiers. The production lot size of an ordered part is adjusted according to the input of new forecast information.

### FIELD OF THE INVENTION

The present invention relates to production management, and more specifically to a production management method highly effective in managing long-lead-time parts without reliance on a large parts warehouse.

### BACKGROUND

Companies manufacturing products by order want to reduce the time between the reception of an order and the delivery of a product. If they only want to be able to ship a product as soon as possible after they receive an order, they only need to keep products in stock. However, many problems may arise when manufacturers carry inventories. The storage entails costs. In addition, it is difficult to make engineering changes to the products in stock. Therefore, it is important for manufacturers not to increase their stock and yet to response quickly to their customers.

A number of approaches to this problems are known such as CTO (Configure-To-Order) in the personal computer industry, DP (Demand Planning), and CRP (Continuous Replenishment Program) in the consumption goods industry.

Especially in the personal computer industry, products and components become rapidly obsolete and customers' demands change fast. Therefore, most companies do not start production until they receive an order, in an attempt to maintain minimum product inventory. They also attempt to minimize parts inventory, and do not order regular parts until they are needed in production. The methods of forward-thinking companies are more drastic: they fully use production scheduling that works dynamically with order receipt information to determine a delivery date and quantity of required parts beforehand, and provide a “delivery order” to a supplier to have the parts supplied to them. If working well, this system can reduce parts inventory to a remarkably small quantity, a quantity sufficient for several days, for example.

To enable such operation, the company must agree with the supplier about a parts supply method. This method is called “informal rolling”. According to the informal rolling system, each time the required quantity of parts is determined, a delivery order is provided to the supplier requesting delivery of the parts.

In the JIT production system in the car industry, a manufacturer has a parts storage next to its assembly plant, where a supplier can directly deliver parts and the manufacturer is supplied with the parts, completely according to a delivery order. The business relationship between the manufacturer and the supplier is strong enough that the manufacturer can be supplied with even intricate unit components conforming to an informal delivery order without delay by providing the informal order to the supplier in advance according to a production plan. While the storage facility may be provided by the manufacturer, stock parts are managed by the supplier. A problem with the JIT production system is that, though it minimizes risk in the parts inventory of the manufacturer, it conversely increases risk in the inventory of the supplier.

For most manufacturers in industries other than the personal computers and cars, relationships with suppliers are not so close. A supplier may supply a wide variety of parts, ranging from general-purpose to custom-ordered parts. There are a huge number of suppliers of all sizes, from large companies to family-run workshops. Also, there are different, equal, or unequal, power relationships between manufactures and suppliers. As is often the case, manufacturers cannot adopt the informal rolling system even if they want to do so because some suppliers are reluctant to accept the informal rolling system.

Another important issue concerning the reduction of lead time is parts procurement. In order that parts used for assemblies are delivered in a timely manner, a required quantity of parts must be ordered in advance. Lead time for substrates containing a large number of electronic devices may be very long. In some cases, they must be ordered several months before assembling. It may be difficult to order only a minimum quantity of custom-ordered parts requiring a special process because such parts are often ordered in bulk as a general rule. In some cases, a manufacturer must have its own parts plant because the production of some precision components requiring intricate engineering is technically difficult to outsource. Consequently, many restraining factors must be considered, such as the inventories of materials, in-process and finished parts, and the operating status of the factory. A problem arises especially when a customer requests a short lead time and the lead time for the acquisition or processing of parts is too long to meet the customer's demand.

It can be understood that an order acceptance date should be set back in order to reduce the lead time between the acceptance of an order and the delivery of parts. Production of the parts is started in advance based on an order forecast, and an order is accepted during a period of time required for the completion of products, including the processing of parts. The finished products can be shipped without keeping them in stock because the order is firmed when the products are finished. Items in progress are kept as work-in-process inventory and provided as work-in-progress inventory when an order is received. The idea is that good use is made of the inventory of work in progress being ordered (inventory inevitably provided for production) to postpone the receipt of an order to reduce lead time. This allows a quick response to demand fluctuations without maintaining parts inventory even for parts for which the informal rolling or JIT system cannot be used.

However, problems may arise when parts are not kept in stock. Suppose that parts are ordered. A built-to-order (BTO) system cannot be used for products requiring a lead time from order to delivery that is shorter than the production lead time between the order of parts and the completion of the assembly of products. This is because the products could not be delivered without delay if the built-to-order system were used. In this case, parts must be ordered based on forecast information before an order is firmed, with consideration given to the production lead time. Therefore, parts are provided based on a forecast of the number of products expected to be ordered with reference to a components list. The number of parts to be ordered is calculated, and the parts are ordered. Parts may range from large ones, such as power supplies and frames, to small ones such as a screw. A procurement lead time is established for each individual part, including internally manufactured parts and purchased parts. Consequently, parts order dates calculated back from the delivery date of a product are different from part to part. On the other hand the forecast represents an estimated quantity of a product expected to be ordered in the next several months, summarized on a weekly (or monthly) basis, which may change with time. Typically, the forecast tends to become more accurate (become closer to the actual number of products ordered) with time. If parts order dates vary depending on differences in procurement lead time, the forecasts change and the numbers of parts to be ordered change.

Variations in the forecasts cannot be avoided. In order to quickly response to demand fluctuations, order quantity must be consistently ascertained. The forecast must be reviewed and updated regularly to keep the estimation information up to date. Differences between the forecast and order quantity must be minimized. Consequently, the forecast will unavoidably change.

When parts are ordered based on a varying forecast, ideally an adequate quantity of components, according to the number of finished products, should be available in order to produce a given model of the product. However, if the forecast changes because of a difference in the timing of the parts order, order quantities differ from one part to another even when the parts are ordered for the production of the same model to be delivered on the same delivery date. This state occurs each time a new forecast is made and must be resolved when an order is eventually firmed.

Another problem arises when ordered parts are finished, delivered, and used in assembly. Parts ordered according to a forecast are delivered after a predetermined lead time. However, the quantity forecast when the parts order was made may differ from the quantity after an order is firmed. The number of parts actually used in production for the received order may not match the number of parts delivered. If the quantity ordered is less than the quantity forecast, parts will be in oversupply. On the other hand, if the quantity ordered is more than the quantity forecasted, the parts will be in undersupply and products cannot be delivered on a due date.

These problems are caused by fluctuations in the forecast. The forecast value used when parts are ordered does not necessarily match the forecast (or ordered) value when the parts are finished or delivered.

Therefore, it is an object of the present invention to provide a production management method that can accommodate (1) variations in the quantities of ordered parts caused by fluctuations in forecasts and (2) differences between the forecasts at the time of order and the time of delivery to quickly respond to demand fluctuations without reliance on a large parts warehouse.

### SUMMARY OF THE INVENTION

The present invention includes a system for managing production of a product made of a plurality of parts based on a forecast of the production plan for the product, the system comprising: (1) a forecast information storage for recording forecast information representing the planned quantity of the product to be produced by assigning a first identifier (tie ID or linkage ID) and second identifier (Forecast Box) to each part, the first identifier being defined based on the planned production date of the product, the second identifier being defined based on the length of time between the due order time of the parts required to produce the product on the planned production date and the planned production date; (2) an order information storage for recording order information representing the ordered quantity of parts required for the production of the product by assigning the first and second identifier to each part; and (3) a production planning module for, in response to input of new forecast information, updating and maintaining information in the forecast information storage and the order information storage and calculating the order quantity of each part actually required for the production of the product based on a total number in the forecast information and the quantity of the part already ordered. The production planning module also has the functions of, in response to the input of the new forecast information, calculating an offset value from a value calculated before the input and propagating the offset value to adjust the production lot size of the ordered parts. The system may also comprise a lot division information management table for managing information about lot division and lot merge performed according to a change in forecast information. Parts information such as the configuration of the parts required for the product to be produced and a lead time required for producing each part is managed in a parts list.

In addition, the present invention includes a method for managing production of a product made of a plurality of parts based on a forecast of a production plan for the product, comprising the steps of: (1) in response to input of forecast information representing the planned quantity of the product to be produced, recording the forecast information representing the planned quantity of the product to be produced by assigning a first and second identifier to each part, the first identifier being defined based on the planned production date of the product, the second identifier being defined based on the length of time between the due order time of the parts required to produce the product on the planned production date and the planned production date; based on the forecast information, (2) recording order information representing the order number of parts required for the production of the product by assigning the first and second identifier to each part; and, at a desired time, (3) calculating the order quantity of each part actually required for the production of the product based on a total number in the forecast information and the quantity of the part already ordered.

The production management method of the present invention may further comprise the step of, in response to the input of the forecast information, calculating an offset value from a value calculated before the input and propagating said offset value to adjust the production lot size of the ordered parts. These and other aspects of the present invention will be more fully appreciated when considered in light of the following drawings and detailed description.

### BRIEF DESCRIPTION OF THE DRAWINGS

FIG. 1 illustrates a configuration of a system according to the present invention;

FIG. 2 is a diagram showing parts to be included in product X and relative dates for ordering the parts;

FIG. 3 illustrates a relationship between forecast management performed on each completion date and variations in forecasts;

FIG. 4 illustrates how order information is derived from forecast information;

FIG. 5 illustrates how the quantity of a part to be ordered is determined;

FIG. 6 is a diagram for illustrating the need for lot resizing according to a difference between an ordered quantity of part and an actual quantity of a delivered product;

FIG. 7 shows correspondence between T when ordered and current forecast F;

FIG. 8 illustrates a first method for determining a lot division position for an ordered part;

FIG. 9 illustrates a second method for determining a lot division position for an ordered part;

FIG. 10 summarizes the first and second methods for determining a lot division position for an ordered part shown in FIGS. 8 and 9;

FIG. 11 is a first diagram illustrating lot division information in a lot division information management table;

FIG. 12 is a second diagram illustrating lot division information in the lot division information management table;

FIG. 13 illustrates the lot division information management table;

FIG. 14 shows a process of the operation on site;

FIG. 15 illustrates relationship between a manufacturing process of an in-house part and lot division/merge;

FIG. 16 illustrates relationship between a delivery/acceptance process of a purchased part lot division/merge;

FIG. 17 illustrates a process from delivery/acceptance to dispatch without lot division;

FIG. 18 shows a parts-order tying list;

FIG. 19 shows a parts quantity management list;

FIG. 20 shows a process chart of an on-site operation using the parts quantity management list; and,

FIG. 21 shows a flowchart of the process procedure for calculating order information shown in FIG. 5.

### DETAILED DESCRIPTION

The production management method and system described above will be further described below. According to a first aspect of a production management method and system of the present invention, a unit period is defined and a calendar is represented by consecutive segmented periods segmented by the unit period. Managing means manage the delivery date of product X and the order time of each part of product X by using the periods. An identifier i is defined for each batch of products X having different delivery dates and a relative amount n is defined that represents that a period is n units before the delivery period of product X in terms of unit period. F (i, n) is defined as an order quantity of product X associated with i that is forecasted at n. T (i, n) is defined as the order quantity of part Bn, which is a predetermined part ordered at n, among parts B of product X associated with i. Fa (i, n) and Ta (i, n) are defined as those of F (i, n) and T (i, n) that belong to the current period.

Projected order quantity registering means registers Fa (i, n) for all i's in the current period. Order quantity calculating means calculate Ta (i, n) for all i's based on registration in the projected order quantity registering means as follows. Let m be any number from 1 to the maximum value of n, which is nmax, and Sa, Sa1, Sb are defined as follows:

Sa: the sum of Fa (i, m) and Sa1,

Sa1: The sum of all of those F (i, m) out of F (i, n), where n=m, that have delivery periods after the current period and are set in periods before the current period,

Sb: The sum of all of those T (i, m) out of T (i, n), where n=m, that have delivery periods after the current period and are calculated in periods before the current period.

Ta (i, m) is calculated based on a difference, Sa−Sb.

If a quantity, k, of part Bn is included in product X, Ta (i, n) would be a value equal to Ta (i, n) multiplied by k where a quantity, 1, of part Bn is included in product X. If a plurality of types of the same part included in product X exist for n and all of the types of the part are to be ordered, Bn1, Bn2, . . . should be defined for the respective types 1, 2, . . . and the order quantity of each type should be calculated. The invention can be applied to any of Bn1, Bn2, . . . which is used as Bn. In order to maintain a predetermined safety stock of each part, an order quantity may be Ta (i, n) plus a predetermined quantity, as appropriate.

An appropriate period may be set according to the nature of the period or the size of a factory, such as a day, a week, ten days, two weeks, or a month. The quantity nmax may not exceed the production period of product X in terms of unit period. For example, if the production period of product X is 50 in terms of unit period, nmax does not exceed 50.

F (i, n) for each i is forecast in each period before its delivery period and Ta (i, n) is set accordingly, thereby allowing the production quantity of product X in each delivery period to be maintained while minimizing a short or excessive parts stock even if F (i, n) changes. In addition, because a different delivery period is set for each i and a part associated with i is delivered so that the delivery period of product X associated with i is observed, the present invention can substantially eliminate a parts warehouse or require only a small parts stock space.

According to a second aspect of the production management method and system of the present invention, m is any number from 1 to nmax, where nmax is the maximum value of n, in the first aspect of the production management method and system of the present invention. Tb (i, m) is defined as all of those T (i, m) out of T (i, n), where n=m, that have delivery periods after the current period and are calculated in periods before the current period. Ta (i, m) plus Tb (i, m) for part Em is represented by Tc (i, m). A lot associated with each Tc (i, m) is considered. Each time the current period is updated, lot divide means perform division or merge of a lot of Tc (i, m) associated with part Bm each of all Ta (i, n) whose n is less than m out of Ta (i, n).

Because each time the current period is updated, the lot associated with Tc (i, m) that is associated with part Bm is divided or merged, which range out of the entire ordered quantity of Bm is assigned as the lot of each Bm associated with i, can be exactly known.

According to a third aspect of the production management method and system of the present invention, m is any number from 1 to nmax, which is the maximum value of n, in the second aspect of the production management method and system of the present invention. A quantity sequence provided by combining the quantities of all Tc (i, m) in the order of delivery period, from earliest to latest, is defined. In this quantity sequence, a base divide is set at a position equal to the quantity of each Tc (i, m). Divide position calculating means indicate a division position of the lot of part Bm for each update of the current period by an offset with respect to the position of a base divide in the quantity sequence. Lot divide means perform lot division or merge based on the indication from the divide position calculating means.

Because the division of Tc (i, m) is set when it is ordered and re-division in the quantity sequence is represented by an offset with respect to the divide of Tc (i, m) when it is ordered, an updated divide position can easily be calculated.

According to a fourth aspect of the production management method and system of the present invention, it is assumed that i increments by one as the delivery period of product X increments by one unit period in the third aspect of the production management method and system. Divide position calculating means calculate an offset P1 of a division position in a quantity sequence of the lots of Tc (i, 2) and Tc (i+1, 2) based on Fa (i, 2) and Fa (i+1, 2). The divide position calculating means also update divide positions in the quantity sequence for corresponding lots of Tc (i, m) and Tc (i+1, m) for m ranging from 3 to nmax in ascending order of m based on P1. Because the divide positions of the corresponding lots of Tc (i, m) and Tc (i+1, m) are calculated in a propagation or recursive manner, time required for the calculation of the divide positions can be reduced.

According to a fifth aspect of the production management method and system of the present invention, k is an integer from 2 to nmax in the fourth aspect of the production management method and system. Divide position calculating means calculate an offset Pk of a division position of the lots of Tc (i+k1, k) and Tc (i+k, k) based on Fa (i, 1), Fa (i+1, 2), . . . , Fa (i+k, K) Divide position calculating means also update divide positions in the quantity sequence for corresponding lots of Tc (i+m−1, k) and Tc (i+m, k) for m ranging from k+1 to nmax in ascending order of m based on Pk.

Because the divide positions of the corresponding lots of Tc (i+m−1, k) and Tc (i+m, k) are calculated in a propagation manner, time required for the calculation of the divide positions can be reduced.

According to a sixth aspect of the production management method and system of the present invention, m is any number from 1 to nmax, which is the maximum value of n in the fifth aspect of the production management method and system. If divide positions of corresponding lots of Tc (i+m−1, m) and Tc (i+m, m) are P in the previous period, divide position calculating means set divide positions on the quantity sequence based on an update in the current period at a position shifted by Pk with respect to P.

Because the divide position of the corresponding lots of Tc (i+m−1, m) and Tc (i+m, m) are shifted by Pk with respect to P in the previous period to calculate the updated divide positions, time required to calculate the divide positions can be reduced.

An embodiment of the present invention will be described below with reference to the accompanying drawings. Tying management will be described first.

Tying or linkage in the manufacturing industry means association between a product and its parts. That is, an association that indicates which product a part is used for, or conversely, which part is required for the production of a product. These associations are contained in a parts list for design. For the purpose of the present invention, an association is one between a product “to be produced (finished) on a certain date” and a part. While the parts list indicates an association between a product and a part at part-number level, it does not manage an association between each individual part and product that indicates that a part ordered on a first date and delivered on a second date is used for a product produced on a third date. The present invention manages a specific association between each individual part and a product. For example, the present invention allows a user to readily know that a quantity, 30, of part B1 is delivered on a first date, 20 of which are used for product X to be finished on a second date and 10 are used for product X to be finished on a third date.

In the manufacturing industry, MRP (Material Requirements Planning) is typically used for determining the quantity and order date of a part. Inputs to the MRP are information such as quantities and production (completion) dates of products. Outputs from the MRP are information such as quantities and order dates of parts. Therefore, the outputs may actually include tying information because an association (tying) between a product and a part is computationally taken into consideration in the MRP. However, the conventional MRP does not output tying information.

The present invention focuses on providing information about how a tying status on date A has changed on date B, in addition to information about the tying status (current status) on date B.

Consider the case where a quantity, 30, of product X was originally planned to be produced as of date A but only 25 of product X was produced on date B. Although a quantity, 30, of part B was ordered on date A because 30 of product X were to be produced on date A, the quantity of part B actually required was only 25. Because the quantity, 30, of part B was delivered, excessive quantity, 5, should be carried over to the next production of product X. This means that the tying status of part B on date A is changed on date B.

If there were a parts warehouse, the warehouse would act as a buffer to accommodate the difference without the need for the management of the change of the tying status. However, because the present invention is intended to be applied to an operation where no warehouse is used, tying management is especially important. A computerized system for solving this problem will be considered below.

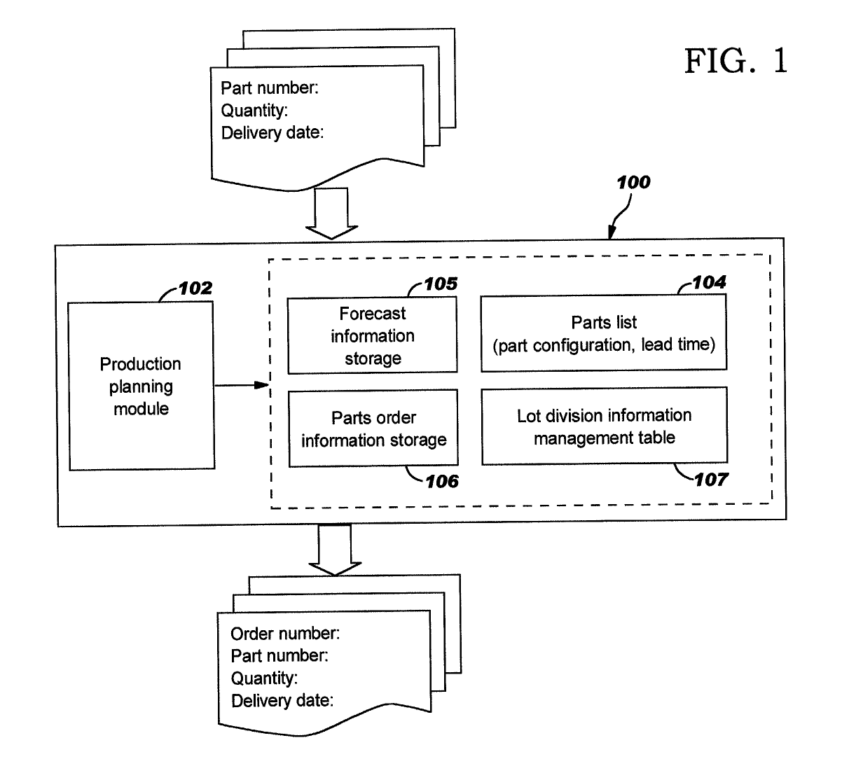

FIG. 1 shows a diagram illustrating functional blocks for embodying the present invention. In particular, a system 100 embodying a production management method according to the present invention comprises a parts list 104 for managing information about the parts configuration required for a product to be produced and a typical lead time required for the production of each part, a storage 105 for recording forecast information representing a planned quantity of the product to be produced (finished) according to a predetermined production plan, a storage 106 for recording parts order information representing ordered quantity of a part required for the production of the product, a lot division information management table 107 for managing information about lot division and lot merge performed according to variations in the forecast, and a production planning module 102 for cooperating with the above-mentioned components to calculate a required (ordered) quantity of a part used in actual production in response to the input of information about the production plan such as the forecast information. The forecast information and parts order information managed by the above-mentioned storages 105, 106 are managed by using a tie ID assigned to a product based on the production date (planned completion date) of the product and a Forecast Box indicating a time period between the current time point and the production date, which will be detailed later, in order to flexibly respond to variations in product forecasts. In order to improve the efficiency of the management, parts on the parts list 104 are managed preferably by grouping according to parts order times (lead times) required for production.

With the configuration described above, the present invention flexibly and efficiently calculates the quantity of a part to be ordered at the present time and adjusts the lot size of the part already ordered (determines a point at which the part lot is divided into a set to be used in the present production and a set to be carried over to the next production in consideration of a quantity previously carried over), based on newly determined forecast information.

Inputs will be first described below. Of the utmost importance in the manufacturing industry is to decide what, when, and how much is to be produced. In full built-to-order manufacturing, these factors are firmed by a received order and do not change after the order. However, to set back an order reception date in order to reduce a lead time between customer's order and the delivery of a product, a part requiring a long lead time or a long processing time must be proactively ordered before the customer's order is received. To order the part before the customer's order is received, the customer's order quantity must be predicted. In an embodiment of the present invention, this predicted quantity is called a forecast. The forecast changes with time. The order also may be changed by the customer after the order is received.

Therefore, a “tie ID” is considered on the basis of a quantity of the product to be produced (finished) on a given date.

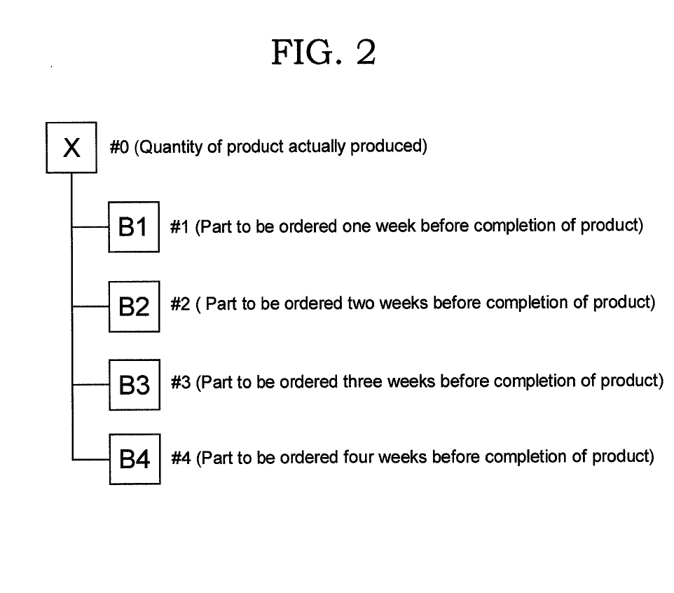

FIG. 2 shows parts to be included in product X and relative order dates of the parts. In the example shown in FIG. 2, it is assumed that product X is made of four parts: part B1 through B4. A calendar is represented by consecutive periods. The delivery date of product X and the order dates of individual parts of product X are managed with the periods. The variable #n indicates a relative amount, representing that a period is n units before the delivery period of product X in terms of unit period. That is, #0 in FIG. 2 represents a period in which the delivery date of product X is included, and periods in which the parts B1 through B2 are ordered are #1, #2, #3, and #4, respectively, in terms of relative amounts.

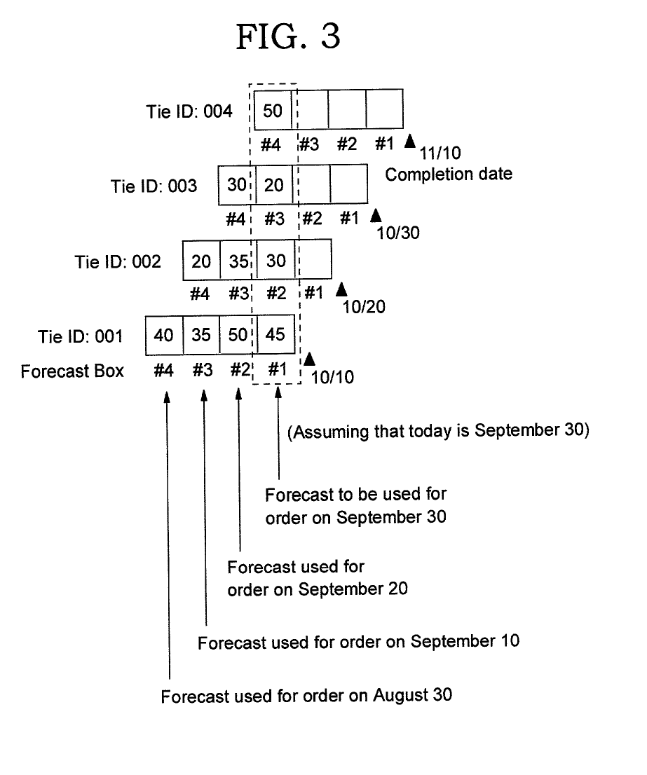

The unit period is 10 days and the relative amount of a period is indicated by #n in FIG. 3. Each date indicates the first day of a period. For example, the completion period (delivery period) of product X having tie ID: 001 (hereinafter, the upper consecutive zeros of a tie ID will be omitted as appropriate. For example, tie ID: 001 will be indicated by tie ID: 1.) is a period from October 10 to 19. The order date of part B4, which must be ordered 4 unit periods before the completion period is in a period from August 30 to September 9 (because the end of August is 31, the period from August 30 to September 9 includes 11 days, rather than 10 days. Such a difference in period including the end of month is neglected.) The completion period of product X having tie ID: 003 is a period from October 20 to 29, which is one period after that of the product with tie ID: 001. The order date of part B4, which must be ordered four unit periods before the completion period of the product is in a period from September 10 to 19. The planned production quantity (forecast) of product X with tie ID: 001 was 40 in period #4 (four unit periods before the completion period and three unit periods before the current period) and changed to 35 in period #3 (three unit periods before the completion period and two unit periods before the current period). The forecast of product X with tie ID: 002 was 20 in period #4 (four unit periods before the completion period and two unit periods before the current period) and changed to 35 in period #3 (the current period which is three unit periods before the completion period). In this way, information concerning tie IDs for managing forecasts (and received orders) is input to the system.

A tie ID is used to manage changes in the planned quantity (forecast) of a finished product in a period n periods before its completion date. To indicate how many periods a period is before a planned completion period, a concept of “Forecast Box” is used. Then individual values for a tie ID can be expressed as follows. More particularly, information input to the system is F (tie ID, Forecast Box): variation in product forecast.

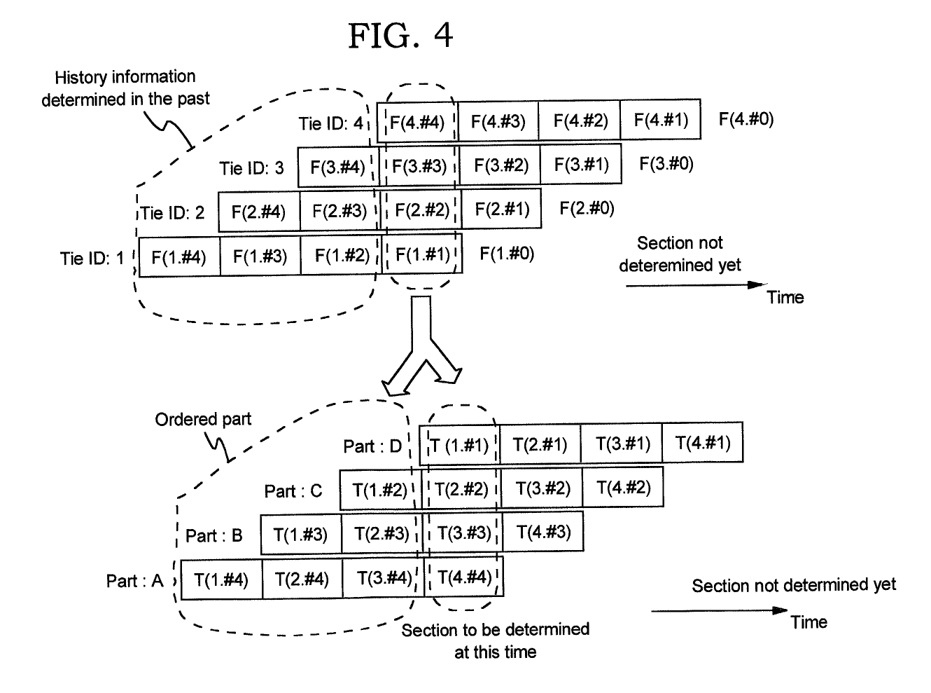

Outputs from the system will be considered below. Output information is divided broadly into two categories (FIG. 4):

(1) The quantity of a part to be ordered at the present time: order quantity of a part that cannot be supplied by a completion period if it is not ordered in the current period, according to the current forecast information (in consideration of the lead time of the product) and;

(2) Variation in association (tying) between a product and a part: a change of association between the product and the part caused by a variation in a forecast (retying, difference adjustment).

Which Forecast Box is used to order each part is determined by calculating backward from the planned completion date of the product. The order quantity of the part is determined based on information (tie ID) regarding the quantity of the product that should be produced on a given date. This is expressed as follows:

T (tie ID, Forecast Box): order quantity of a part changing in accordance with changes in forecast.

One function of the system is to calculate T (tie ID, Forecast Box) from F (tie ID, Forecast Box). Basically, T is calculated as follows: (a) Fs in the present and past periods that have not yet reached completion periods of product X and are in the same relative periods are grouped, and the sum of Fs in each group is calculated. For example, F (4, #4), F (3, #4), F (2, #4), F (1, #4) are grouped because tie IDs 1, 2, 3, and 4 have their delivery periods in the future and have the same relative period, #4, for which forecasts are made. Then the sum of Fs is calculated. Then, (b) Ts in the past periods for which the delivery dates of products X have not yet reached and have the same relative periods in which they have been ordered are grouped. Then the sum of Ts in each group is calculated. For example, T (1, #4), T (2, #4), and T (3, #4) are grouped because tie Ids 1, 2, and 3 have their delivery period in the future and have the same relative period, #4. Then the sum of Ts is calculated. Then, (c) a difference between groups having the same relative period in (a) and (b) is calculated as the value for T in the current period that has the same relative period. For example, the current T (4, #4) ={F (4, #4)+(3, #4)+F (2, #4)+F (1, #4)}−{T (1, #4)+T (2, #4)+T (3, #4)}.

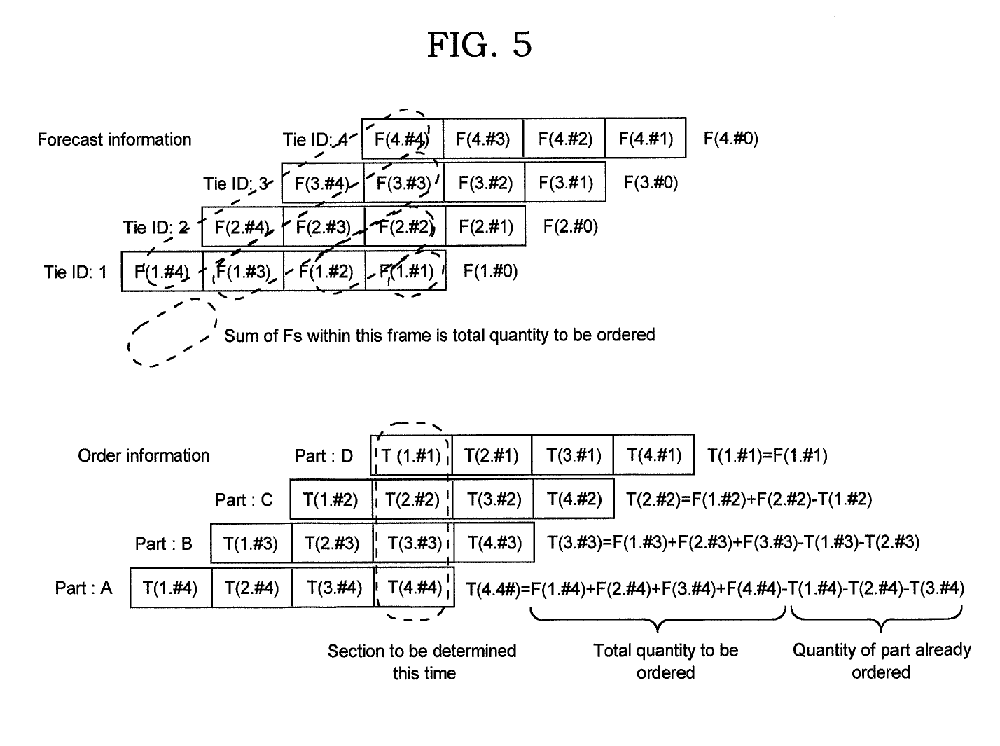

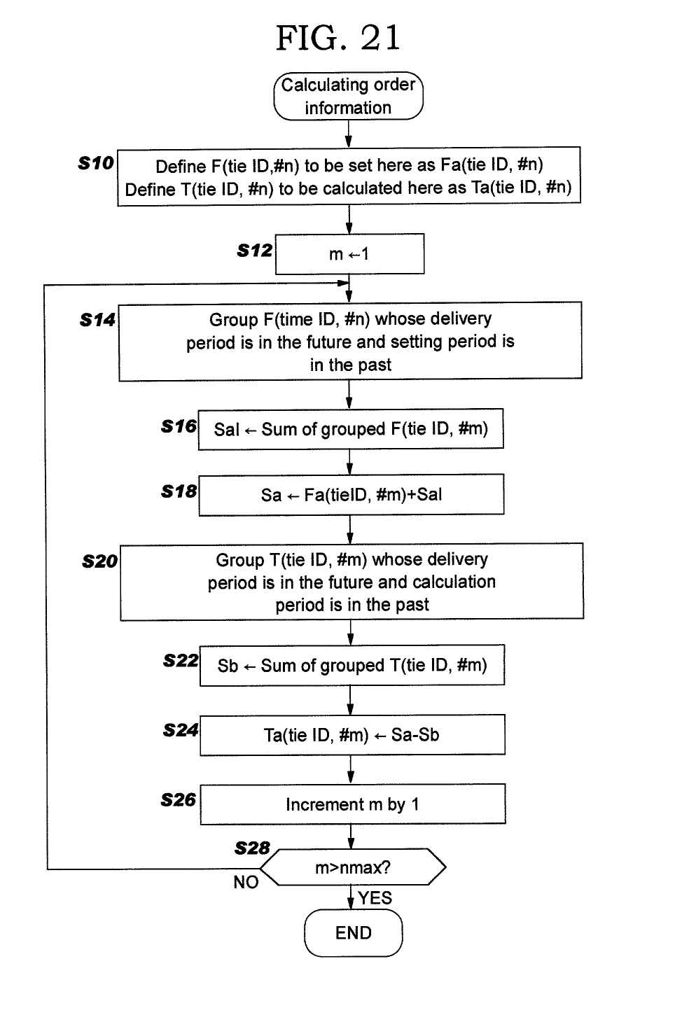

FIG. 21 shows a flowchart of the process shown in FIG. 5. At step S10, F (tie ID, #n) that is set this time is defined as Fa (tie ID, #n) and T (tie ID, #n) that calculate this time is defined as Ta (tie ID, #n). In the example shown in FIG. 5, Fa (tie ID, #n) is F (1, #1), F (2, #2), f (3, #3), and F (4, #4) and Ta (tie ID, #n) is T (1, #1), T (2, #2), T (3, #3), and T (4, #4). At step S12, an initial value of 1 is assigned to m. At step S14, Fs (tie ID, #m) that have delivery period in the future, that is, after the current period, and have set in the past periods, that is, before the current period, are grouped. In the example shown in FIG. 5, if m=1, then there are no Fs (tie ID, #1) that are grouped at step S14. If m=2, Fs (Tie ID, #2) grouped at step S14 are only F (1, #2). If m=3, Fs (tie ID, #3) grouped at step S14 are F (1, #3) and F (2, #3). At step S16, the sum of Fs (tie ID, #m) grouped at step S14 is calculated and defined as Sa1. At step S18, Fa (tie ID, #m) +Sa1 is defined as Sa. At step S20, Ts (tie Id, #m) that have delivery period in the future, that is, after the current period, and have calculated in the past periods, that is, before the current period, are grouped. In the example in FIG. 5, if m=1, there are no Ts (tie ID, #1) that are grouped at step S20. If m=2, Ts (tie ID, #2) grouped at step S20 is only T (1, #2). If m=3, Ts (tie ID, #3) grouped at step S20 are T (1, #3) and T (2, #3). At step S22, the sum of Ts (tie ID, #m) is calculated and defined as Sb. At step S24, Sa−Sb is substituted into Ta (tie ID, #m). In this way, Ta (tie ID, #m) for given m is calculated. At step S26, m is incremented by one. At step S28, if m exceeds nmax (where nmax is the maximum value for n), that is, if the calculations of Ta (tie ID, #m) for all values for m from 1 to nmax have been completed, this program will end. Otherwise, the program returns to step S14 for calculating Ta (tie ID, #m) for a new value for m.

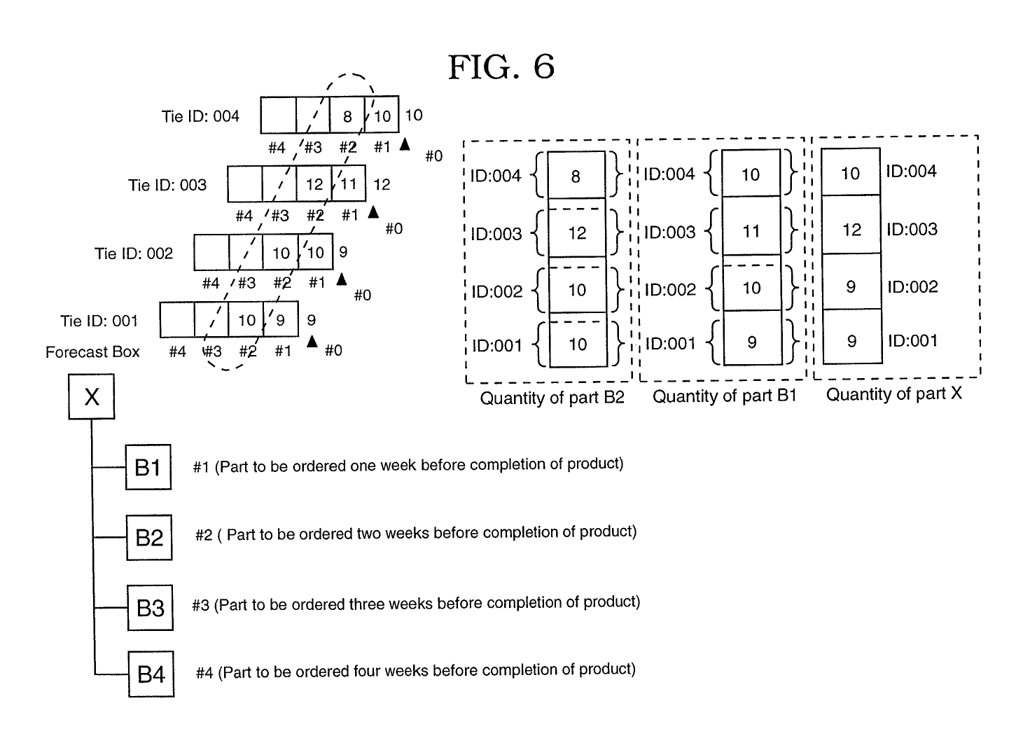

Another output is a change in association between the product and the part caused by a variation in a forecast. For example, the ordered quantity of part B2 is 10 in tie ID: 001 (in Forecast Box #2) in FIG. 6 but only 9 are actually used for product X. In this case, 10 are delivered but they are “lot-divided” into nine and one. Nine are used in tie ID: 001 and one is carried over to tie ID: 002. Ten of part B2 are ordered in tie: 002. However, because the quantity of product X has become nine, only 9 of part B of 11, which is delivered 10 plus 1 carried over from tie ID: 001, are used, leaving 2. Given that parts are used under a first-in-first-out rule, the remainder of tie ID: 001 and the ordered quantity in tie ID: 002 should be merged. This is called “lot merge.”

In view of operations on the factory floor, the second output is more important as information indicating “lot division” or “lot merge” according to a change in a forecast, than as information for association (a new tie) between a product and its parts based on the new forecast. In order to obtain the information indicating lot division/merge, association (tying) between the product and the part may be recalculated to obtain a difference between the result and the previous association (tying) each time the forecast changes. However, experience has shown that this calculation method is computationally intensive, and a simpler calculation method is desired. A fast calculation method that allows information indicating lot division/merge to be provided will be described below.

It is difficult to calculate association (tying) between a product and its parts all over again. The only information actually required, however, is a difference caused by a change in forecasts. Because the tying has been calculated already based on the previous forecast, only a difference caused by the forecast change is calculated, rather than calculating the tying all over again.

As described earlier, F (tie ID, Forecast Box)=T (tie ID, Forecast Box) if there is no change in a forecast. A difference caused by a change in the forecast is a deviation from this relationship. Forecasts (in the upper half part of FIG. 4) are arranged horizontally, one tie ID in each row. On the other hand, orders (in the lower half part of FIG. 4) are arranged horizontally, one part in one row. If there is no change in the forecasts, that is, F=T, the only difference between them is that forecasts are arranged in descending order of tie ID and orders are arranged in ascending order of tie ID. As forecasts change, lot divisions or lot merges occur at the level of parts.

Therefore, the following description will focus on the arrangement on a part basis shown in the lower half part of FIG. 4.

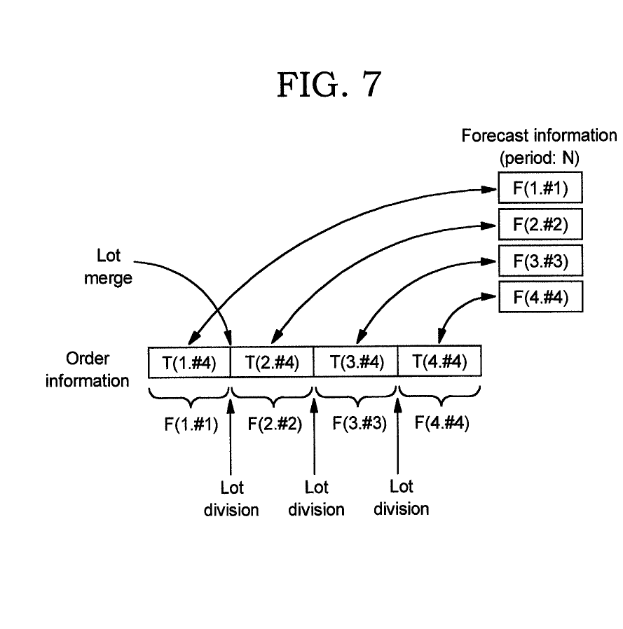

FIG. 7 shows a correspondence between T when a part is ordered and the current forecast F. A difference between T and F triggers lot division/merge. The correspondence between F and T is as follows in FIG. 6: F (1, #1) corresponds to T (1, #4), F (2, #2) corresponds to T (2, #4), F (3, #3) corresponds to T (3, #4), and F (4, #4) corresponds to T (4, #4). Lot division/merge occurs at positions indicated in FIG. 6, which are automatically determined by a difference between T and F. If a forecast is accurate, the positions of the lot division and the lot merge coincide and a ordered lot is used as is.

The procedure (FIG. 7) described above is used for calculating the position of lot division/merge of a single part (a part with a consistent Forecast Box). The positions of lot division/merge should be calculated for all parts. The parts with different lead times are ordered with different Forecast Box numbers. Therefore, the calculation must be performed for all the Forecast Boxes, rather than only a particular Forecast Box. A method is available that simplifies and speeds up the calculation of lot division/merge positions for all the Forecast Box by reducing the number of calculations.

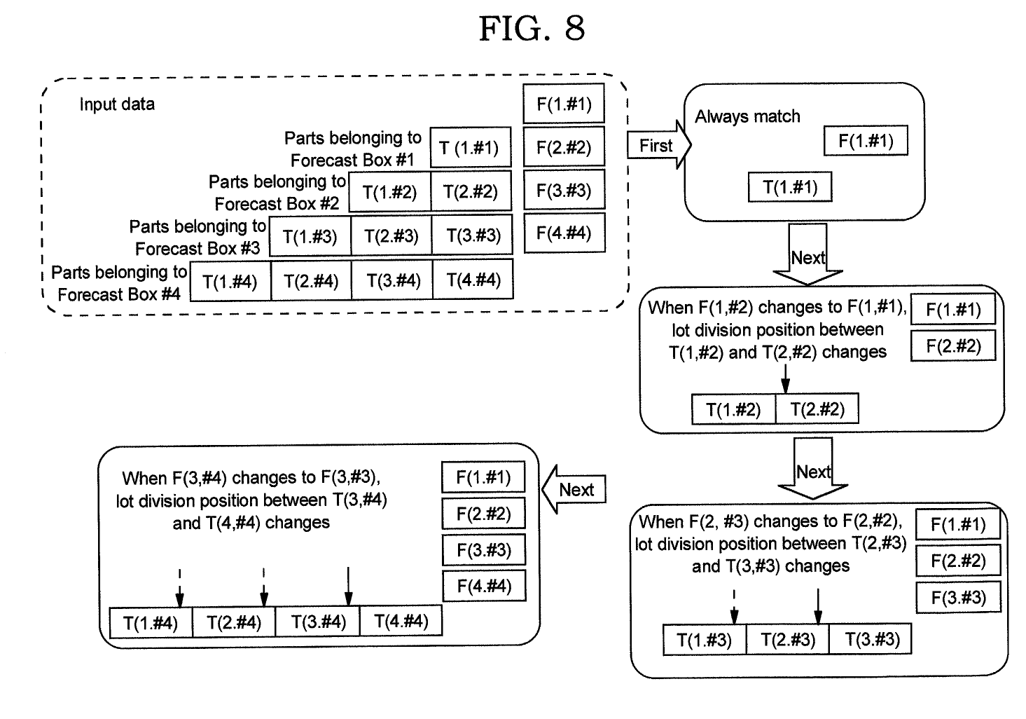

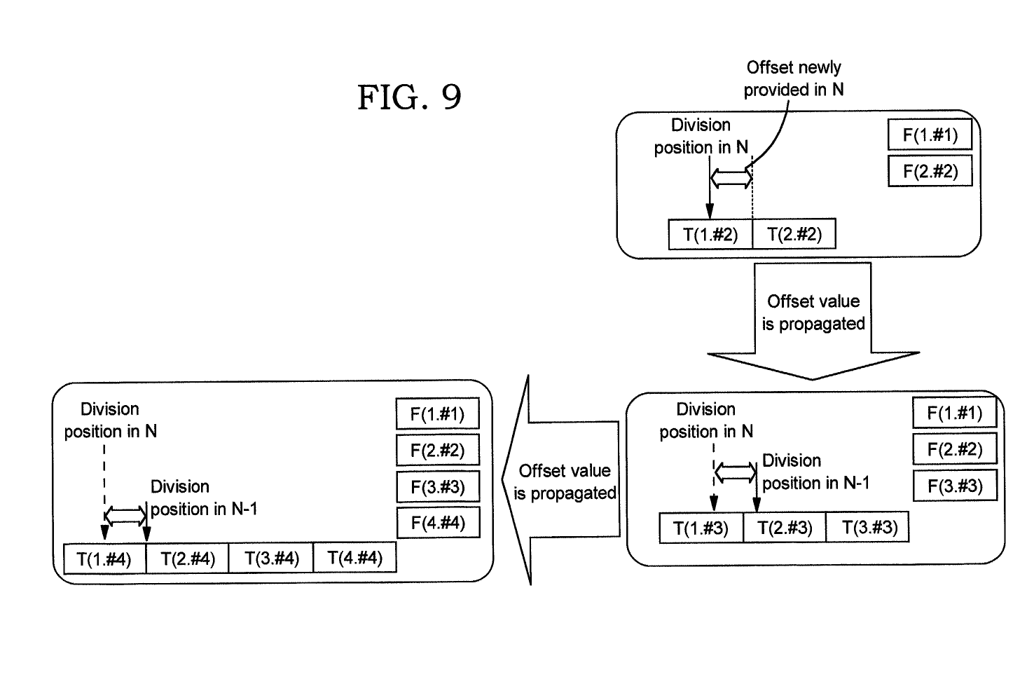

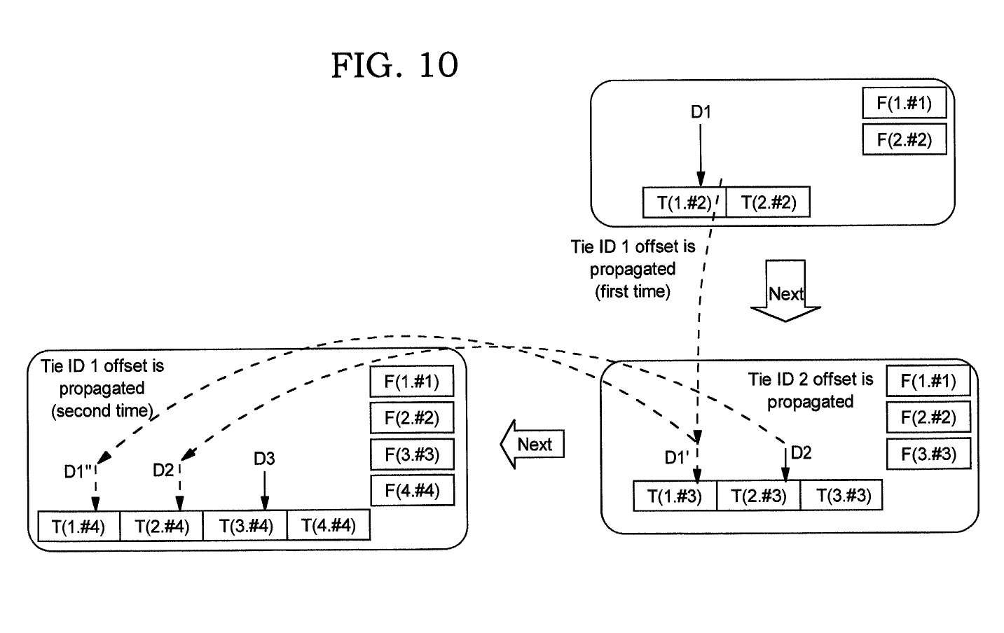

Referring to FIG. 8, the fast difference calculation method will be described below. When all Forecast Boxes are contained in the diagram shown in FIG. 6, it will be as shown in the upper left part of FIG. 8. In each division position update block in FIGS. 8 through 10 Fs are arranged in column and Ts are arranged in row and the sum, Ft, of Fs in one column is equal to the sum, Tt, of Ts in one row. Consequently, the first and second division position from the right end of each column are determined by Tt minus the lowermost F. For example, in the right lowermost block in FIG. 8 (the lower right blocks in FIGS. 9 and 10), Ft=F (1, #1)+F (2, #2)+F (3, #3) and Tt=T (1, #3)+T (2, #2)+T (3, #3). That is, Ft=Tt. Therefore division position of T (2, #3) and T (3, #3) will be at the position of Tt−F (3, #3).

In FIG. 5, the sum of forecasts in a dashed frame that have the same Forecast Box number and have not reached delivery period by the current period was calculated as the order quantity of each part with each Forecast Box. In FIG. 8, this can be calculated by using a relation between forecast information in a column and order information in a row in each block as follows:

Ta (i, #m)=Sa−Sb,

where Ta (i, #m): present order quantity of parts associated with Forecast Box number, #m,

Sa: sum Sa of forecasts F (i, #n) with n<m, among forecast information F (i, #n) in the current period, and

Sb: sum of orders T (i, #m) placed in periods before the current period and have delivery periods after the current period.

In order to speed up the calculation, lot division/merge positions for the part with the shortest lead time are calculated first, then lot division/merge positions for parts with longer lead times are calculated in sequence. This means that the calculations for the parts are performed in ascending order of Forecast Box number. This method can reduce the number of calculations dramatically for the reason described below.

In FIG. 9, once a difference between a position and the previously calculated position is calculated, the difference can be propagated to the subsequent positions, rather than calculating each lot division/merge position, to reduce the number of calculations. A difference to be calculated now is a difference in period N and the previously calculated difference is a difference in period N-1. If calculations are performed for parts in ascending order of Forecast Box number, a difference caused by a change in forecasts can simply be propagated to other parts with larger Forecast Box numbers, thus eliminating the need for calculating new differences.

FIG. 10 summarizes the method for determining the division positions shown in FIGS. 8 and 9. As described earlier, the rightmost division positions D2, D2 in each block are determined by Tt−lowermost F. D1 and D2 are propagated toward division position determination blocks with larger Forecast Box number in sequence. D1′ is determined by the propagation of D1, then D2 is determined, D1″ is determined by the propagation of D1′, D2′ is determined by the propagation of D2, and finally D3 is determined.

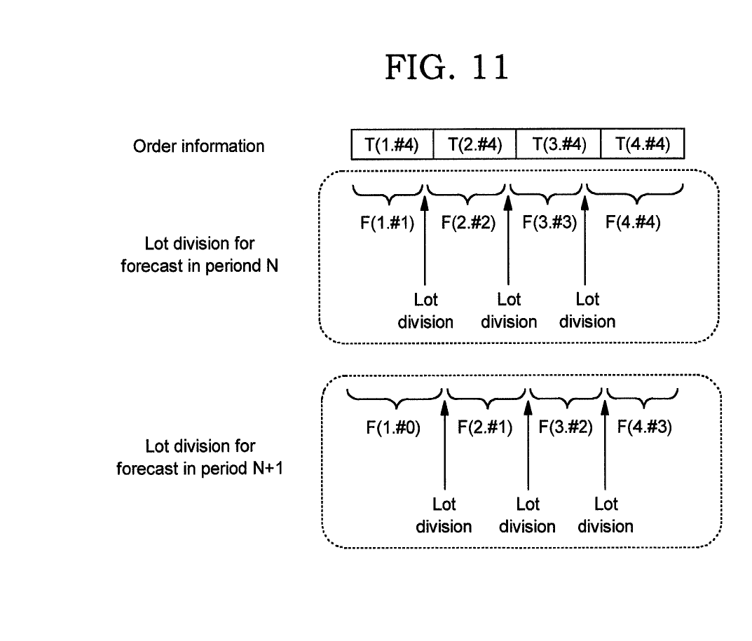

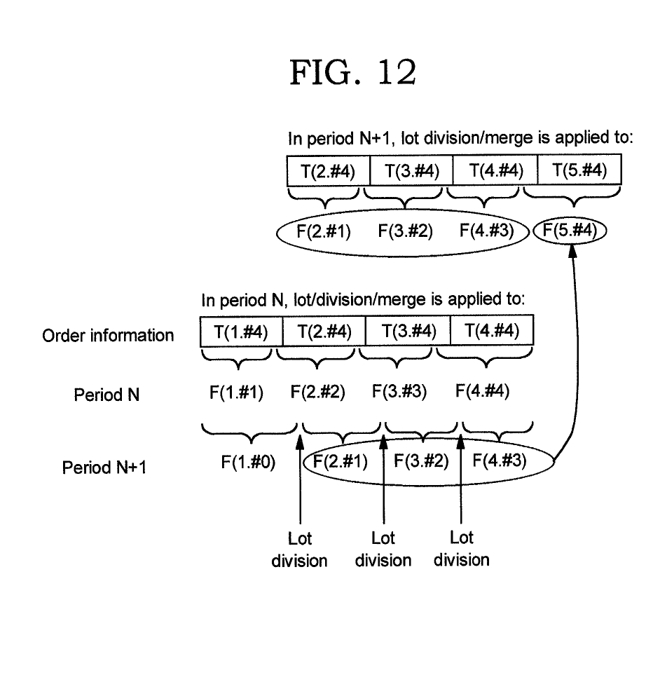

FIGS. 11 and 12 show lot division information. Lot divisions for order information T (1, #4), T (2, #4), T (3, #4), and T (4, #4) will be described below by way of illustration. The order periods of T (1, #4), T (2, #4), T (3, #4), and T (4, #4) occur in this order, one a unit period after the other. In period (absolute period) N, F (1, #1), F (2, #2), F (3, #3), and F (4, #4) are set. The aggregate lot (the lot of part B4 corresponding to #4) of T (1, #4), T (2, #4), T (3, #4), and T (4, #4) is divided at positions of quantities equal to F (1, #1), F (2, #2), F (3, #3), and F (4, #4) and the resulting lots are assigned to the respective tie codes 1, 2, 3, and 4.

In period N+1, F (1, #0), F (2, #1), F (3, #2), F (4, #3), and F (5, #4) are set. F (1, #0) corresponds to delivery period of #0, or code 1, and is a firm quantity of order received, rather than a 30 forecast. The reception of an order may be firmed in a period with Forecast number #R1 (where R1 is an integer larger than zero; for example, R1=1 or 2), that is, before #0. That is, an order is not received in a period less than R1 from the current period. In this case, F (tie ID, Forecast #R2) for R2 (where 1≦R2≦R1) is equal to F (tie ID, Forecast #0) and is actually a firmed value rather than a forecast. Such a firm value is also called forecast herein. Lots of T (1, #4), T (2, #4), T (3, #4), and T (4, #4) are initially divided according to F (1, #0), F (2, #1), F (3, #2), and F (4, #3). A lot for F (1, #0) of part B4 regarding #4 is consumed for product X regarding tie code 1 in period N+1 and excluded from the managed lot of part B4 as shown in FIG. 12. Instead, T (5, #4) is added to the managed lot of part B4. In this way, the lot of part B4, which is the aggregate of T (2, #4), T (3, #4), T (4, #4), and T (5, #4) is divided at positions of quantities equal to F (2, #1), F (3, #2), F (4, #3), and F (5, #4) as shown in FIG. 12 and each lot is assigned to tie code 2, 3, 4, and 5, respectively.

Thus, when lot a division/merge occurs with a change in a forecast, the calculation is performed by focusing on a difference, thereby allowing the number of calculations to be significantly reduced. Generally, accurately computing a tie between a product and its parts requires a huge number of calculations. Calculating a lot division/merge based on such computation would require a vast amount of time. On the contrary, the algorithm described above can be used to significantly reduce the number of calculations because the need for recalculations is eliminated by propagating a result of one calculation. The tying management is therefore feasible in terms of calculation efficiency even in the case where forecasts change.

The lot division positions are expressed by offsets with respect to a boundary position of T. In FIGS. 1 and 2, it is assumed that the values for T and F are as follows:

T (1, #4)=12, F (1, #1)=11, F (1, #0)=15, T (2, #4)=8, F (2, #2)=6, F (2, #1)=4, T (3, #4)=9, F (3, #3) =8, and F (3, #2)=10.

In this case, an offset in absolute period N for T (1, #4) will be F (1, #1)−T (1, #4)=11−12=−1 and an offset in absolute period N+1 will be F (1, #0)−T (1, #4)=15−12=3. An offset for T (2, #4) in absolute period N will be {F (1, #1)+F (2, #2)}−{T (1, #4)+T (2, #4)}=(11+6)−(12+8)=−3 and an offset in absolute period N+1 will be {F (1, #0)+F (2, #1)}−{T (1, #4)+T (2, #4)}=(15+4)−(12+8)=−1. An offset in absolute period N for T (3, #4) will be {F (1, #1) +F (2, #2) +F (3, #3)}−{T (1, #4)+T (2, #4)+T (3, #4)}=(11+6+8)−(12+8+9)=−4. An offset in absolute period N+1 will be {F (1, #0)+F (2, #1)+F (3, #2)}−{T (1, #4)+T (2, #4)+T (3, #4)}=(15+4+10)−(12+8+9)=0.

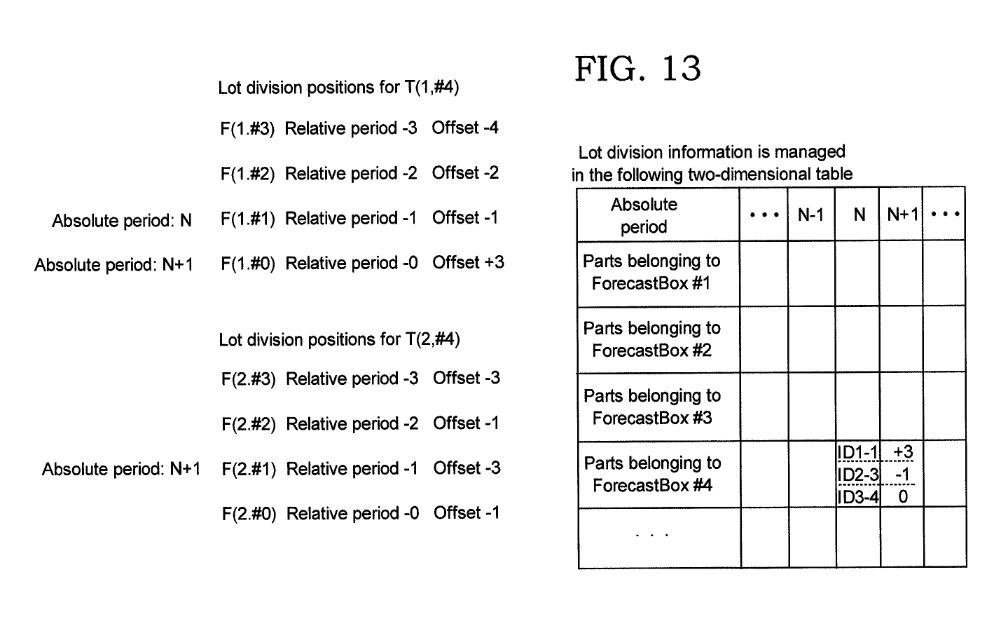

FIG. 13 shows a two-dimensional management table of lot division information. The exemplary values for F and T given above are also used in this example. Division information about parts belonging to Forecast Box number #4 and having tie code 1, 2, and 3 is represented by offsets in the two-dimensional management table. The offsets N are −1, −3, and −4 in absolute period N and 3, −1, and 0 in absolute period N+1, respectively.

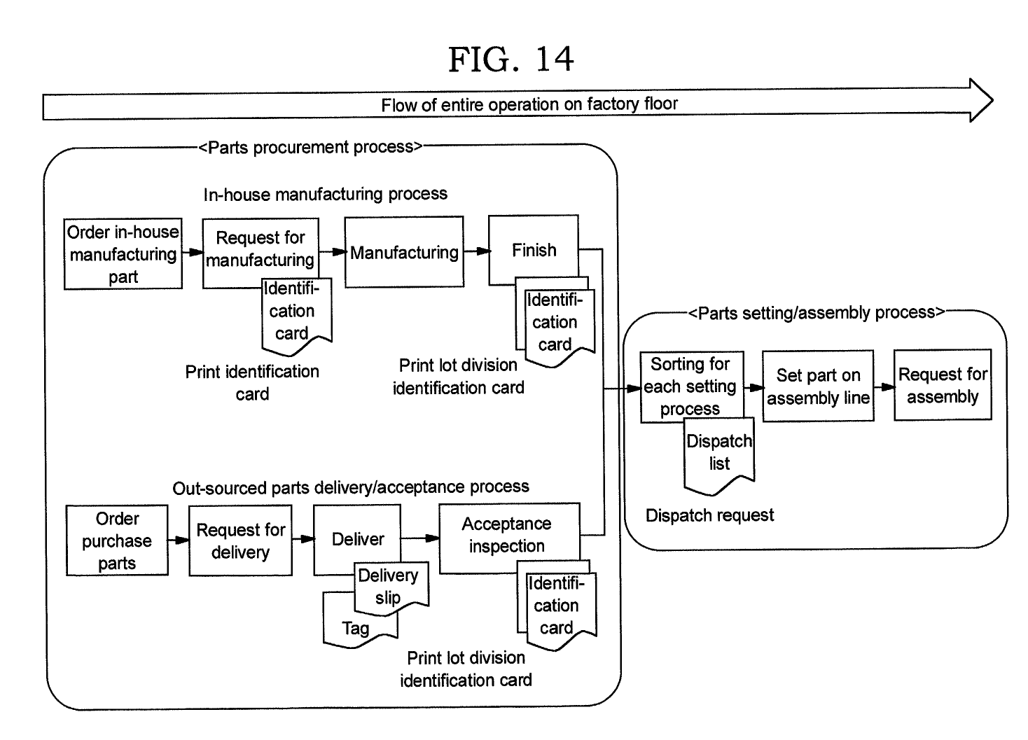

An operation of tying management in a factory floor will be described below. FIG. 14 shows the flow of the entire operation (from the start to an assembly direction) in the factory of a precision machine manufacturer. The entire operation is broadly divided into two process: a parts procurement process and a parts dispatching/assembly process. The procurement process varies depending on an in-house manufacturing process and outsourcing, and is therefore classified into two processes. Tying management basically provide the following information:

(1) Ordered lot A is divided into B and C: A→B+C (lot division)

(2) Remainder Z of the previous lot is merged with B to provide N: Z+B→N (lot merge); and

(3) Remainder C of the current lot is kept for the next production: C→Z (Z for next production).

Lot division and lot merge in an in-house process will be described below. In an in-house manufacturing process shown in the upper left part of FIG. 14, a slip called “identification card” is attached to each lot of a part for identifying the part, and handled together with the part. If lot division/merge occurs, of course the actual lot of parts is divided/merged. The identification card should be divided/merged and reattached to the divided/merged lot. Newly printed identification cards are attached to each of the divided/merged lot(s) before the completion of the lot division/merge.

In terms of tying management data, the lot division/merge is performed each time a forecast changes. However, it is difficult to immediately reflect all such changes in the process on the factory floor and to apply the lot division/merge to all the parts, because the number of lot division/merge tasks increases as the number of the parts increases. The tasks would become uncontrollable if a distinctive line were drawn somewhere between parts to which lot division/merge should be applied and others to prevent an excessive increase of workload.

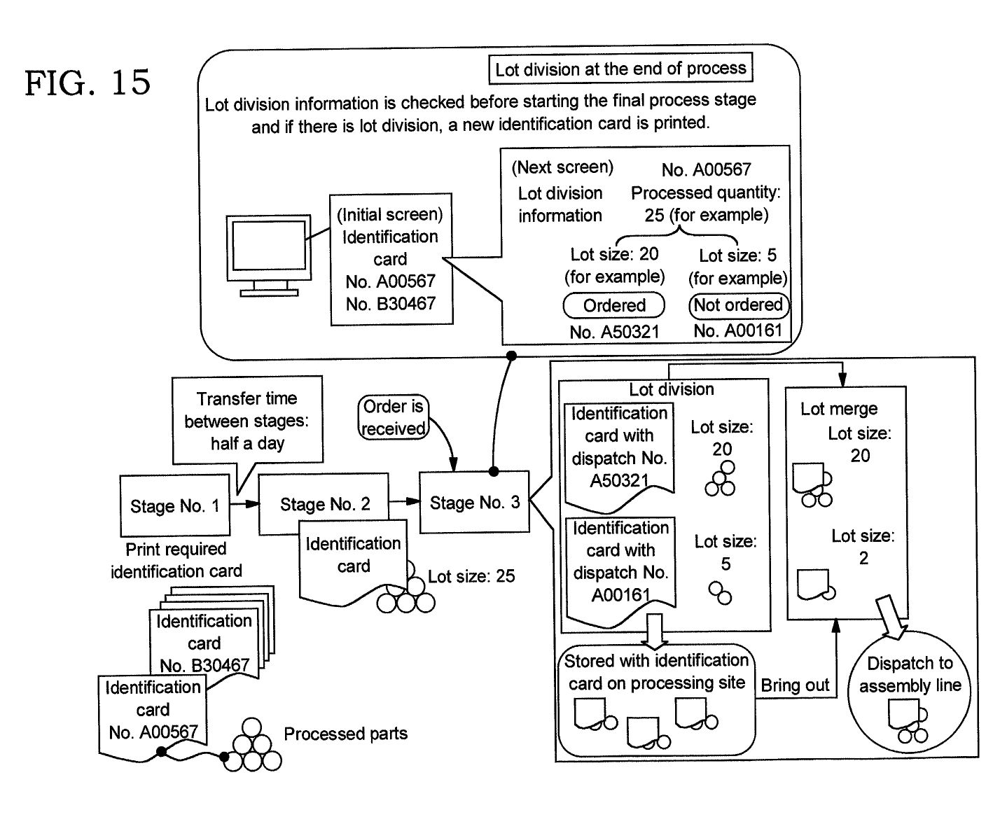

FIG. 15 is a chart showing points at which the above-mentioned decision is made. In this example, lot division/merge tasks are performed only at the final process stage. No lot division/merge is performed in midstream of the process. Lot division/merge is performed at the final stage of the process because the next process is an assembly process. In other words, the lot division/merge is performed immediately before the assembly. A parts manufacturing factory and an assembly factory may be in different sites. The lot division/merge is not performed in the assembly factory immediately before the assembly; instead, it is performed in the parts manufacturing factory. Because it is desirable that parts are assigned only to a product with a firm order, and it is assumed that the order has been firmed before the final process stage, the final stage is appropriate for performing lot division/merge. At this time point, parts tied to forecasts are re-tied to the order. To minimize lot division/merge workload in the manufacturing process, the lot division/merge task should be performed only once, preferably at the last process stage after the order is firmed.

Given that no change to tying occurs once an order is firmed, lot division/merge may be performed at any other process stage, besides the final process stage, after the order is firmed. However, if a worker in midstream of the process were to print an identification card in some cases but not in other cases, it could be confusing. In view of simplicity and clarity of rules on the factory floor, it is preferable that the task be performed only at the final stage.

At the final process stage, a lot of a lot-divided/merged part that is tied to the order is immediately dispatched to the assembly line, together with the appropriate identification cards. However, the remainder of a lot (carried over for the next production and not assigned to an order) is stored on the site to wait for merger with the next lot, without being provided to the assembly line. This lot is tied to a forecast with the next tie ID. An identification card is attached to each lot stored on the site.

In order to adjust differences in forecasts, parts may be stored and managed at the final process stage in this operation. Therefore storage space may be provided for temporarily storing the parts. The more kinds of part, the more a management load befalls workers. It is very important to impart an understanding of the system to on-site workers in advance to improve the operation as described above.

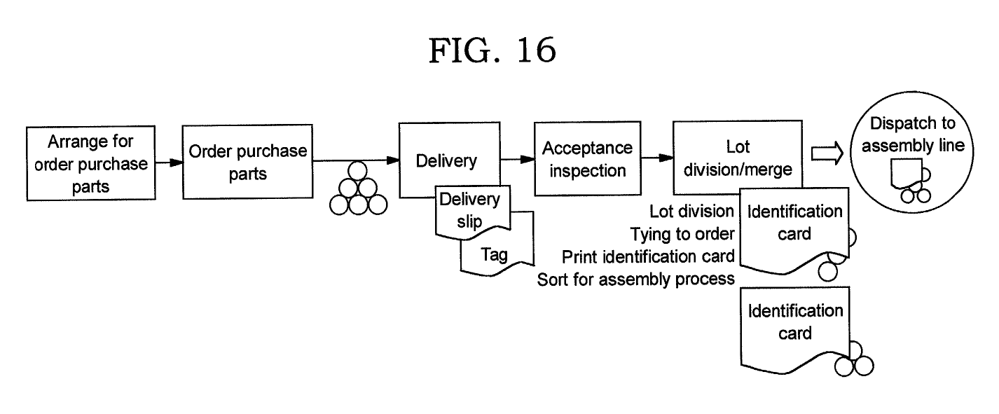

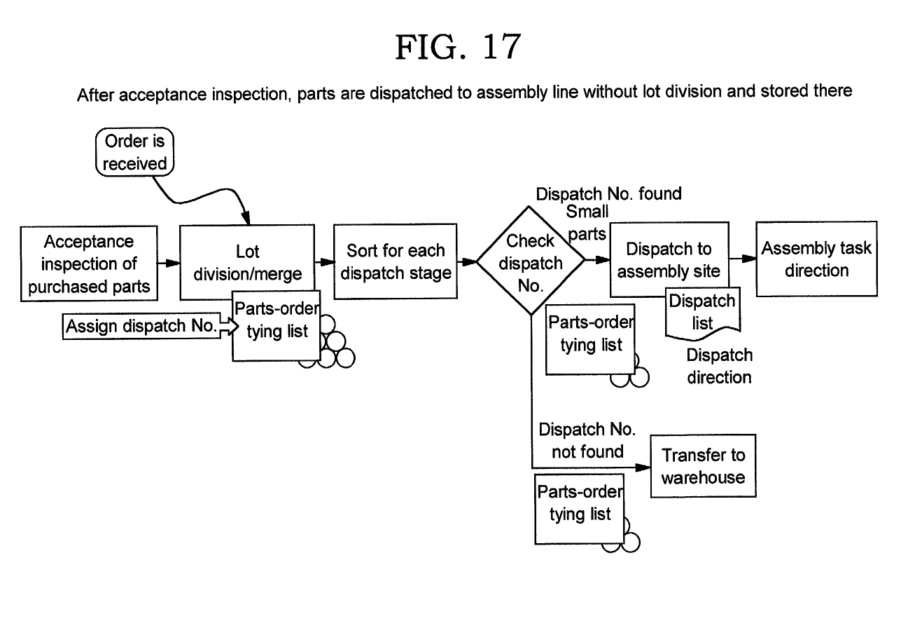

An operation for procured parts will be described below. A process from the procurement order to an acceptance inspection is shown the lower left part of FIG. 14. Ordered purchased parts are typically delivered in a batch together with a tag. Usually, changes in forecasts occur in the process between the order and delivery; therefore, a lot division/merge tasks are required at a certain time point after the delivery. There are two ways for these tasks as shown in FIGS. 16 and 17. One is a straightforward approach as shown in FIG. 16, where lot division/merge is performed after the completion of the acceptance inspection. The idea shown in FIG. 16 is based on the assumption that lot division/merge is completed before assembly is started, as with in-house manufactured parts. Thus, tying management does not affect the operation in an assembly process.

A batch (ordered quantity) delivered is treated as one lot until the acceptance inspection is performed in order to increase the efficiency of work on the factory floor. After the completion of the acceptance inspection, lot division/merge is performed and the task is completed by attaching a newly printed identification card to the purchased parts.

In the operation shown in FIG. 16, a bottleneck may occur because lot division/merge tasks physically concentrate at one position, where a heavy load is placed on workers. This operation is not necessarily good when workspace or the number or workers is restricted.

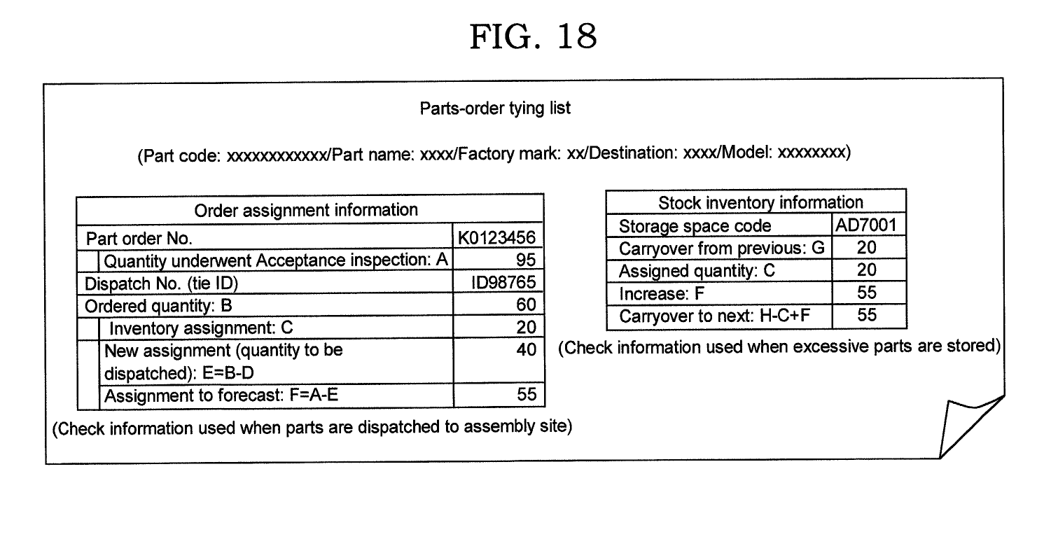

An operation for purchased parts, including dispatch and assembly tasks will be described below. A method avoiding the above-described bottleneck is shown in FIG. 17. A major feature of this operation is that no lot division/merge tasks are actually performed. The operation for in-house manufactured parts (FIG. 15) and the operation shown in FIG. 16 are based on the assumption that lot division/merge tasks are completed before the assembly process. In the operation shown in FIG. 17, on the other hand, the lot size of a purchased part when ordered is not changed and dispatched to an assembly process without performing any lot division/merge tasks. Therefore, tying management affects the assembly process in this operation. A “parts-order tying list” indicating the tying status of the current part is printed and attached to the part after the completion of an acceptance inspection. FIG. 18 shows an example of the “parts-order tying list.”

The “parts-order tying list” provide information in easily visible form indicating to what degree an originally ordered part agrees with the received order/forecast, the quantity of the remainder of the previous lot, and the quantity of the remainder left after this assembly. Parts are provided to and stocked at an assembly site together with the part-order tying list. Parts tied to a received order from the stocked parts are immediately used in assembly. Parts that are not tied to the order to be assembled remain after the assembly. The remaining parts are tied to and used for the next order received.

In this operation, the parts should be managed properly so as not to be lost in process. Care should be taken so that the tied parts are used appropriately and that parts to remain are left properly. This check should desirably be performed with a minimum workload. Therefore the quantity of a part stocked at assembly site is counted each time the assembly is completed. If the counted quantity agrees with the quantity of carryover stock on the parts-order tying list, there is no problem. The workload on the site can be significantly reduced because the quantity of a part to be counted is at its minimum after the completion of assembly.

The operation shown in FIG. 17 replaces an actual lot division/merge task with a task of counting the quantity of stock parts remaining after assembly with reference to parts-order tying list at the assembly site. The parts-order tying list can be output by performing tying management adequately, and therefore, this may be an effective production operation.

In order to control a lot division/merge properly, the quantity of a part should be known exactly. If there were a warehouse, the exact quantity of the part could be known when parts are put into or taken out of the warehouse or an inventory is taken. However, to address this issue, someone needs to take the workload. The workload is placed on a worker at the final process stage in FIG. 15, an acceptance inspector in the operation in FIG. 16, or a worker on the assembly site in FIG. 17. The workload is minimized in FIG. 17 by counting the quantity of a part remaining after assembly.

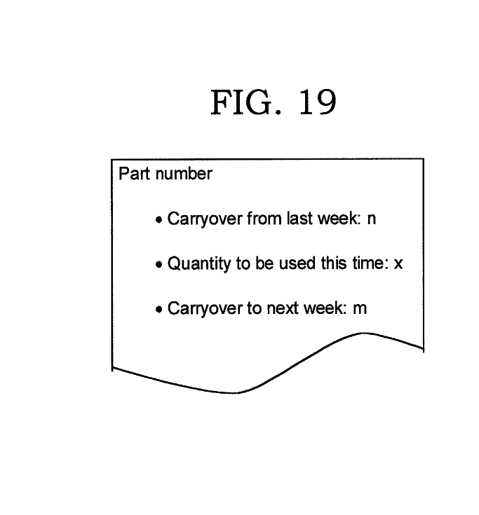

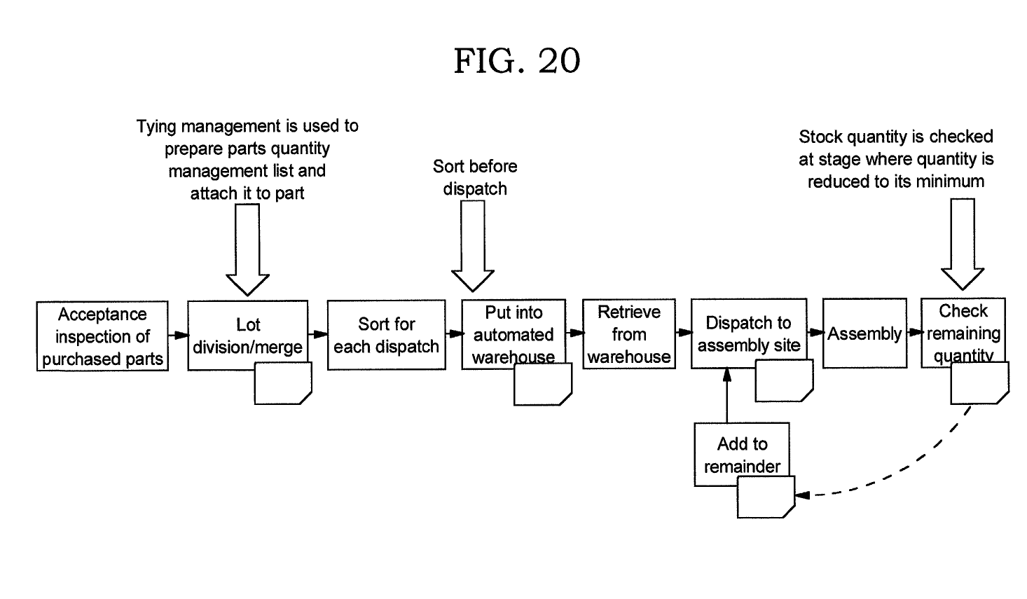

A parts quantity management list may be used instead of the parts-order tying list. FIG. 19 shows an example of the parts quantity management list. FIG. 20 shows a process chart of an on-site operation using the parts quantity management list. The parts quantity management list is used in putting parts into an automated warehouse as follows.

(1) When a batch of parts arrives to be put in the automated warehouse, a parts quantity management list is attached to the batch.

(2) If there is no carryover from the last week or to the next week, no parts quantity management list is attached.

(3) When a pallet is taken out from the automated warehouse, the parts quantity management list attached when the parts were put into the warehouse is provided to an assembly site.

(4) Task 1 on assembly site: If carryover from the last week is not zero, parts remaining in the last week pallet are put into a pallet for this week. The actual quantity of the part is checked against the parts quantity management list.

(5) Task 2 on assembly site: Assembly for this week is performed. Check to see if X quantity of the part is used. If no parts quantity list is attached, check to see if all the quantity of the part is used.

(6) Task 3 on assembly site: After the assembly for this week is completed, check to see if the quantity of carryover to the next week listed on the parts quantity management list matches the quantity of the part remaining in the pallet.

(7) The parts quantity management list is output from the tying management system (a difference between a change in a forecast and ordered quantity is controlled and request lot division).

(8) If there is any change to the ordered quantity or features after the batch of parts is dispatched from the automated warehouse, a new parts quantity management list is printed and the parts quantity management list on site is replaced with it.

From the foregoing description, those skilled in the art will appreciate that the present invention provides advantages that include:

(1) If a product order (forecast) changes, relationships required for responding to the change can completely be controlled.

(2) When ordered parts are delivered, a lot division/merge occurs so that the parts are tied to the newest product order; therefore, parts inventory management is not required.

(3) Because lot division positions are completely controlled, correspondence between a changing forecast and an ordered part can be readily known; therefore, the effect of engineering changes on parts and a product can be easily studied.

(4) Ordered quantities of parts are precisely controlled according to changes in forecasts, thus minimizing the ordered quantities of parts (work-in-progress stock) and avoiding shortage of parts in the final assembly.

(5) Because lot division/merge is performed carefully, first-in-first-out management of parts is enabled.

(6) The quantity of a newly ordered part can easily be calculated.

(7) Result of calculation for period N−1 is used to calculate a lot division position in period N and an offset is propagated to significantly reduce the amount of calculation.

The foregoing description is, however, illustrative rather than limiting, and the scope of the present invention is limited only by the following claims.

We claim:

1. A system for managing production of a product made of a plurality of parts based on a forecast of a production plan for the product, comprising:
a forecast information storage for recording forecast information representing a planned quantity of said product to be produced by assigning a first and a second identifier to each part of the plurality of parts, said first identifier based on a planned production date of the product, said second identifier based on a length of time between a due order time of parts required to produce said product on said planned production date and the planned production date;
an order information storage for recording order information representing an order quantity of parts required to produce the product by assigning said first and second identifier to each part; and,
a production planning module for, in response to input of new forecast information, updating and maintaining information in said forecast information storage and said order information storage and calculating the order quantity of each part actually required for production of the product based on a total number in the forecast information and a quantity of the part already ordered.

2. The production management system according to claim 1, wherein said production planning module, in response to the input of the new forecast information, calculates an offset value from a value calculated before said input and propagates said offset value to adjust a production lot size of ordered parts.

3. The production management system according to claim 2, further comprising a lot division information management table for managing information about lot division and lot merge performed according to a change in forecast information, wherein,
adjustment of the production lot size performed in said production planning module is performed based on a determination of a lot division position using said lot division information management table.

4. The production management system according to claim 1, further comprising a parts list for managing parts information, including a configuration of parts required for the product to be produced and a lead time required to produce each part.

5. A method for managing production of a product made of a plurality of parts based on a forecast of a production plan for the product, comprising the steps of:
in response to input of forecast information representing a planned quantity of said product to be produced, recording the forecast information representing the planned quantity of said product to be produced by assigning a first and a second identifier to each part of the plurality of parts, said first identifier based on a planned production date of the product, said second identifier based on a length of time between a due order time of parts required to produce said product on said planned production date and the planned production date;
based on said forecast information, recording order information representing an order quantity of parts required to produce the product by assigning said first and second identifiers to each part of the plurality of parts; and
at a desired time, calculating the order quantity of each part actually required for a production of the product based on a total number in the forecast information and a quantity of the parts already ordered.

6. The production management method according to claim 5, further comprising a step of, in response to the input of the forecast information, calculating an offset value from a value calculated before said input and propagating said offset value to adjust a production lot size of the ordered parts.
